(19) United States
(12) Patent Application Publication
(10) Pub. No.: US 2002/0191014 A1
(43) Pub. Date: Dec. 19, 2002

(54) Graphical user interfaces for software management in an automated provisioning environment

(76) Inventors: Vivian G. Hsieh, Santa Clara, CA (US); Joshua Atir, Sunnyvale, CA (US)

Correspondence Address: James A. LaBarre, BURNS, DOANE, SWECKER & MATHIS, L.L.P., P.O. Box 1404, Alexandria, VA, 22313-1404, US

(21) Appl. No.: 09/843,701

(22) Filed: Apr. 30, 2001

(51) Int. Cl. G09G 5/00

(52) U.S. Cl. 345/738

(57) ABSTRACT

A graphical user interface for software management of devices associated with different customer infrastructures is described. The interface provides the user with a series of informational screens which rapidly provide the significant software management information which will be of interest to operations personnel. Additionally, graphical user interfaces according to the present invention provide techniques for rapid and repeatable installation and updating of operating system, application and customer software.

### FIELD OF THE INVENTION

The present invention is directed to graphical user interfaces generally and, more particularly, to graphical user interfaces which provide for the provisioning of servers and other computing devices that provide support for sites that are hosted on the Internet, intranets, and other communication networks.

### BACKGROUND OF THE INVENTION

The growing popularity and increasing accessibility of the Internet has resulted in its becoming a major source of information, as well as a vehicle for inter-party transactions, in a variety of environments. For instance, a number of different types of entities, such as government agencies, school systems and organized groups, host Internet and/or intranet web sites that provide informational content about themselves and topics related to their interests. Similarly, commercial enterprises employ web sites to disseminate information about their products or services, as well as conduct commercial transactions, such as the buying and selling of goods. To support these activities, each web site requires an infrastructure at one or more centralized locations that are connected to a communications network, such as the Internet. Basically, this infrastructure stores the informational content that is associated with a particular site, and responds to requests from end users at remote locations by transmitting specific portions of this content to the end users. The infrastructure may be responsible for conducting other types of transactions appropriate to the site as well, such as processing orders for merchandise that are submitted by the end users. A significant component of this infrastructure is a web server, namely a computer having software which enables it to receive user requests for information, retrieve that information from the appropriate sources, and provide it to the requester. Web sites which provide more complex services, such as online ordering, may also include application servers to support these additional functions.

In the case of a relatively small entity, the infrastructure to support its web site may be as simple as a single server, or even a portion of a server. Conversely, a large, popular web site that contains a multitude of content and/or that is accessed quite frequently may require numerous web servers to provide the necessary support. Similarly, web sites for commercial entities, via which transactional operations are conducted, may employ multiple application servers to support transactions with a large number of customers at one time. In addition to servers, the infrastructure for a web site typically includes other types of computing devices such as routers, firewalls, load balancers and switches, to provide connectivity, security and efficient operation.

In addition to the hardware components associated with a web site's infrastructure, a number of software components are also typically involved therewith. The term “provisioning' is used herein to refer to, among other things, the installation of the software that is executed by the device to perform the functions assigned to it, and the subsequent configuration of that software to optimize its operation for the given site. Such provisioning initially occurs when the web site is launched, i.e. when one or more servers are connected to an appropriate communications network such as the Internet, and loaded with the programs and data content necessary to provide the services associated with the site. Thereafter, a need for further provisioning may arise, particularly in the case of a successful web site, when additional servers must be added to support an increasing number of requests from end users. In another instance, the provisioning of the servers and other computing devices may be required as part of a disaster recovery operation, for example a sudden interruption in power, an attack by a hacker, or corruption of stored software and/or data.

The provisioning of a server or other device that supports the operation of a web site involves several discrete steps. First, the appropriate operating system software must be loaded onto the device. Thereafter, software applications that are required to support the particular functions or services associated with the site are loaded, such as database software, credit card processing software, order processing software, etc. After they have been loaded, these applications may need to be configured, e.g. their operating parameters are set to specific values, to support the requirements of the particular site and/or optimize their performance for that site. Finally, the content associated with the individual pages of the web site must be loaded, after which further configuration may be required. The order in which these various components are loaded onto the server and configured can be quite critical, to ensure compatibility of the various programs with one another.

In the past, the hardware arrangements and interconnections, as well as the provisioning of web servers, was often carried out and annotated manually. In other words, each item of software was individually loaded onto the server and then configured by a person having responsibility for that task. The hardware interconnectivity was frequently ad hoc and occasionally poorly documented. One problem with such an approach is the fact that it consumes a significant amount of time. For a relatively large site that is supported by multiple servers, the provisioning could take several days to be completed, thereby delaying the time before the site can be launched and/or upwardly scaled to accommodate increasing traffic. Another, and perhaps more significant, limitation associated with the manual provisioning of devices is the lack of repeatability in the software configurations. More particularly, whenever manual operations are involved in the installation of software, there is always the possibility of human error, such as the failure to install one of the required components, or the loading of the various items of software in the wrong order. Such errors can result in misoperation or total failure of the web site, and can be extremely time consuming to discover and correct.

In addition, when a configuration adjustment is made on one device to improve its performance, if that change is not recorded by the person making the adjustment, it may not be carried over to subsequent devices of the same type when they are provisioned. This latter problem is particularly acute if a device should experience a failure a considerable period of time after the given device was configured. If the person who was responsible for originally configuring the device is no longer available, e.g. he or she has left the employ of the company hosting the site, it may not be possible to reconstruct the original configuration if it was not recorded at the time it was implemented. The same concerns arise if the site needs to be upwardly scaled by adding more devices of the same type after the employee has left.

To overcome some of the problems associated with the installation of software on multiple computers, various techniques have been developed which permit software to be automatically deployed to the computers with minimum involvement by humans. However, these techniques are limited in the types of environments in which they can be utilized. For example, in an enterprise where all of the users interact with the same legacy applications, a “cookie cutter” type of approach can be used to deploy the software. In this approach, every computer can have the same, standard set of programs, each with the same configuration. Once the software programs and settings have been determined, they can be packaged in a fixed format, sometimes referred to as a “ghost” or “brick”, and automatically disseminated to all of the appropriate computers. Thus, whenever a change is made to the standard configuration, it can be easily distributed to all of the users at once. Similarly, if a particular user experiences a failure, for instance due to a computer virus, the standard package can be readily installed on the user's computer, to restore the original functionality.

However, this type of automated deployment is not effective for situations in which computers, such as servers, need to be customized to accommodate the individual requirements of varied users. One example of such a situation is a data center which may house the infrastructure for hundreds of different web sites. The hardware and software requirements for these sites will typically vary among each site. For instance, each site will likely have a different business logic associated with it, i.e. the informational content and services associated with a given site will not be the same as those of any other site supported by that data center. These differences may require a combination of hardware and software which is unlike that of any other site. Similarly, different web site developers may employ different platforms for the sites, thereby necessitating various combinations of operating systems and application programs on the servers of the respective sites. Furthermore, different types of equipment may be utilized for the sites, thereby adding to the complexity of the provisioning process. In some cases, the same site may require a variety of different hardware devices, operating systems and application programs to handle all of the different services provided by that site. For an entity that is responsible for managing the varied infrastructure of these sites, such as a data center operator or a third-party infrastructure utility provider, the known approaches to automated software deployment are not adapted to meet the high degree of customization that prevails in these types of situations. Rather, because of the flexibility that is required to accommodate a different configuration of hardware and/or software for each site, manual provisioning is still being practiced to a large extent, with all of its attendant disadvantages.

An exemplary framework for the automated provisioning of servers and other devices that support various types of network-based services, such as the hosting of an Internet or intranet web site, is described in U.S. patent application Ser. No. 09/699,329, entitled “Automated Provisioning Framework For Internet Site Servers” to Raymond Suorsa, filed on Oct. 31, 2000. The present invention relates to graphical user interfaces which provide high level mechanisms by way of which the software management, in particular the customer's software, for devices disposed within an automated provisioning environment can be implemented in a repeatable and well-documented manner and which permits system operators to coordinate and monitor the loading and modification of software for a plurality of different customers.

### SUMMARY OF THE INVENTION

According to exemplary embodiments of the present invention, these and other drawbacks and limitations of conventional systems are overcome by graphical user interfaces for viewing and managing software associated with devices in one or more data centers and associated with different customer infrastructures. Exemplary interfaces provide the user with a series of informational screens which rapidly provide the significant software configuration information which will be of interest to operations personnel.

Upon reading the detailed description, it will be appreciated that graphical user interfaces according to the present invention provide mechanisms and methods for enhancing software management, particularly within automated provisioning environments. Among other things, these graphical user interfaces provide mechanisms for easily and rapidly managing the way in which software is loaded onto customers' devices while at the same time protecting each individual customer's software security and confidentiality. This latter feature is achieved by, for example, limiting actions to be performed by the user to GUI portions which relate to only one customer. From the foregoing description it will be apparent that those GUI portions which list multiple customers typically do not include GUI action elements, which are reserved for GUI portions relating to individual customers. Additionally, those GUI portions that are associated with individual customers only list, and provide management action options for, software associated with that customer.

According to one exemplary embodiment, a graphical user interface (GUI) according to the present invention includes: a first user interface element actuable to access a portion of the graphical user interface, which portion displays a list of software groups which are available for management for one of a plurality of customers.

These and other features of the invention are explained in greater detail hereinafter with reference to an exemplary embodiment of the invention illustrated in the accompanying drawings.

### BRIEF DESCRIPTION OF THE DRAWINGS

FIG. 1 is a block diagram of the basic logical tiers of a web site;

FIGS. 2a and 2b are more detailed diagrams of the devices in an exemplary web site;

FIG. 3 is a block diagram of one exemplary embodiment of the hardware configuration for a web site in a data center;

FIG. 4 is a general block diagram of a data center in which the infrastructures having devices that are viewed and configured using graphical user interfaces according to the present invention can be implemented;

FIG. 5 is a block diagram of an exemplary provisioning framework which interacts with graphical user interfaces in accordance with the principles of the invention;

FIG. 6 depicts a main menu of a graphical user interface according to an exemplary embodiment of the present invention;

FIG. 7 illustrates the concepts of OS roles, APP roles and Customer (Content) roles according to exemplary embodiments of the present invention;

FIG. 8 depicts an exemplary bundle of software according to exemplary embodiments of the present invention;

FIGS. 9A-9K depict exemplary GUI screens associated with software bundle management according to exemplary embodiments of the present invention;

FIGS. 10A-10L depict exemplary GUI screens associated with software role management according to exemplary embodiments of the present invention; and

FIGS. 11A-11C depict portions of a graphical user interface for determining and operating on software dependencies in accordance with exemplary embodiments of the present invention.

### DETAILED DESCRIPTION

To facilitate an understanding of the principles of the present invention, it is described hereinafter with reference to its application in the provisioning of devices that support web site operations, such as servers, load balancers, firewalls, and the like. Further in this regard, such description is provided in the context of a data center, which typically accommodates the infrastructure to support a large number of different web sites, each of which may have a different configuration for its infrastructure. It will be appreciated, however, that the implementation of the invention that is described hereinafter is merely exemplary, and that the invention can find practical application in any environment where the automated provisioning of computer resources is desirable. Thus, for example, the principles which underlie the invention can be employed to provision computing devices in the networks of an enterprise, or in any other situation in which there are a sufficient number of computing devices to realize the benefits of automated provisioning.

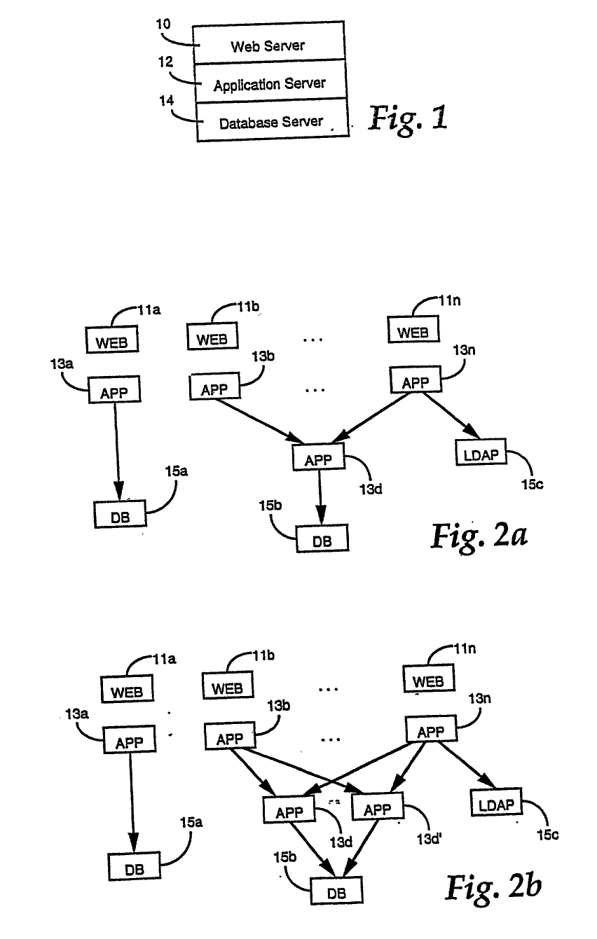

Prior to discussing the specific features of exemplary embodiments of the invention, a general overview of the infrastructure for hosting a web site will first be provided. Fundamentally, a web site can be viewed as consisting of three functional tiers. Referring to FIG. 1, one tier comprises a web server tier 10. The web server is the combination of hardware and software which enables browsers at end user locations to communicate with the web site. It performs the task of receiving requests from end users who have connected to the web site, such as HTTP requests and FTP requests, and delivering static or dynamic pages of content in response to these requests. It also handles secure communications through a Secure Socket Layer (SSL), and the generation of cookies that are downloaded to browsers. Typically, since these types of operations do not require a significant amount of processing power, the web server can operate at relatively high volume rates. The throughput capacity of this tier is usually determined by the amount of server memory and disk storage which is dedicated to these operations.

Another tier of the web site comprises an application server tier 12. This component performs dynamic transactions that are much more computationally intensive, such as order processing, credit card verification, etc. Typically, the application server implements the development environment that defines the business logic and presentation layer associated with a given site, i.e. its functionality as well as its “look and feel”. The performance of this tier is normally determined by the amount of CPU processing power that is dedicated to it. Separation of the web servers and the application servers into different tiers ensures reliability and scalability.

The third tier of the site comprises a database tier 14. This tier stores information relevant to the operation of the site, such as customer demographic and account information, available stock items, pricing, and the like. Preferably, it is implemented with a relational database architecture, to permit the data to be manipulated in a tabular form. Connection pooling to the database can be performed by the application servers, to minimize redundant calls and thereby preserve processing power.

While the fundamental architecture of a web site can be viewed as comprising these three tiers, in an actual implementation the structure of the web site can be significantly more complex. Depending upon the size and requirements of the site, in some cases the database tier can be combined into the application server tier. Even more likely, however, is an architecture in which one or more tiers is divided into several layers. This occurrence is particularly true for the application server tier, because it implements the business logic of a site. Depending upon the types of transactions to be performed by the site, the application server tier may require a number of different types of specialized application servers that are interconnected in various ways. One example of such is depicted in FIG. 2a. In this situation, the site includes a number of web servers 11a, 11b, . . . 11n. Each of these web servers may have the same software and same configuration parameters. The site also includes a number of application servers 13a, 13b, . . . 13n. In this case, however, not all of the application servers are the same. For instance, server 13a communicates with a first type of database server 15a, whereas servers 13b and 13n communicate with another application server 13d at a different level, which may be a highly specialized server. This server may communicate with a second type of database server 15b to carry out the specialized services that it provides. In addition, the server 13n may communicate with a directory server 15c.

If the performance of the server 13d begins to degrade due to increased traffic at the web site, it may be necessary to add another server 13d′, to provide additional CPU capacity, as depicted in FIG. 2b. However, because of the architecture of the site, the automated provisioning task becomes more complex, since the application server 13d is different from the other application servers 13a, 13b, etc., in both its configuration and its connection to other devices. Hence, not all of the application servers can be treated in the same manner. Furthermore, since the business logic of a given site is likely to be different from that of other sites, the configuration parameters that are employed for the site of FIG. 2a may not be appropriate for the devices of any other site, which increases the complexity of the provisioning process even more.

In many instances, the infrastructure for supporting a web site is housed in a data center, which comprises one or more buildings that are filled with hundreds or thousands of servers and associated equipment, for hosting a large number of different web sites. Typically, each floor of the data center contains numerous rows of racks, each of which accommodate a number of servers. In one configuration, each web site may be assigned a portion of a server, or portions of several servers, depending upon its requirements. This approach is typically employed by Internet service providers (ISPs), and is referred to as a “multi-tenancy” configuration, wherein multiple sites may be resident on a given server.

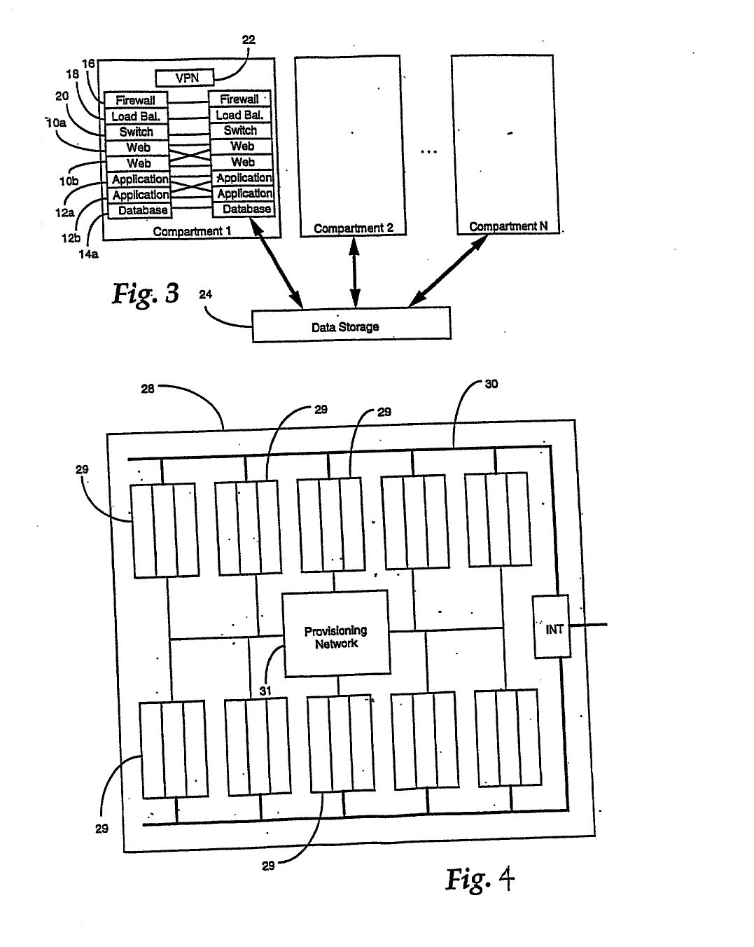

In an alternate configuration, each site is allocated a discrete compartment within the data center, with the servers and other computing devices within that compartment being dedicated to hosting the services of the given site. FIG. 3 is a block diagram illustrating this latter configuration. This figures illustrates three exemplary web site compartments, each of which accommodates the equipment for hosting a web site. Thus, in the illustrated embodiment, each compartment includes one or more web servers 10a, 10b, one or more application servers 12a, 12b, and a database server 14a, to provide the three functional tiers. In addition, the components of the web site infrastructure may include a firewall 16 to provide security against attacks on the site, a load balancer 18 for efficient utilization of the web servers and the application servers, and a switch 20 for directing incoming data packets to the appropriate servers. These devices in the web site compartment can be securely connected to the host entity's computer system via a virtual private network 22. To avoid a single point of failure in the web site, additional redundant components are included, and like components are cross-connected with one another. This feature of redundancy and cross-connection adds another layer of complexity to the automated provisioning process, particularly as the web site grows so that the number of devices and their cross-connections increase and become more complicated to manage.

The physical storage devices for storing the data of a web site can also be located in the compartment, and be dedicated to that site. In some cases, however, for purposes of efficiency and scalability, it may be preferable to share the data storage requirements of multiple compartments among one another. For this purpose, a high capacity storage device 24 can be provided external to the individual compartments. When such a configuration is employed, the storage device 24 must be capable of reliably segregating the data associated with one compartment from the data associated with another compartment, so that the different hosts of the web sites cannot obtain access to each others' data. Examples of storage devices which meet these requirements are those provided by EMC Corporation of Hopkinton, Mass. For additional discussion of the manner in which devices of this type can be incorporated into an infrastructure such as that depicted in FIG. 3, reference is made to U.S. patent application Ser. No. 09/699,351, filed on Oct. 31, 2000, entitled “A Data Model For Use In The Automated Provisioning of Central Data Storage Devices”, the disclosure of which is incorporated herein by reference.

One feature of the present invention comprises graphical user interfaces and methods associated with the use of such interfaces for automating the management of software roles, bundles and packages used to operate each customer's specific infrastructure. Further in this regard, an objective of the invention is to provide graphical user interfaces for deploying and loading software specific to each customer.

An overview of one environment in which the present invention operates is depicted in FIG. 4. A data center 28 is partitioned into multiple customer compartments 29, each of which may be arranged as shown in FIG. 3. Each compartment is connected to a backbone 30 or similar type of common communication line for access by computers which are external to the data center. For instance, if the compartments are associated with Internet web sites, the backbone 30 constitutes the physical communication path via which end users access those sites over the Internet. The backbone may also form the path via which the web site hosts can securely communicate with the devices in their individual compartments, for instance by virtual private networks.

Also located in the data center 28 is a provisioning and management network 31. This network may be located within another compartment in the data center. This network is connected to the computing devices in each of the compartments 29 which are to be managed. In the embodiment of FIG. 4, the provisioning network 31 is illustrated as being connected to the compartments 29 by a network which is separate from the backbone 30. In an alternative implementation, the provisioning network can communicate with the compartments over the backbone, using a secure communications protocol.

The provisioning network 31 may be operated by the owner of the data center, or by a third-party infrastructure utility provider. While FIG. 4 illustrates all of the compartments being connected to the network 31, this need not be the case. To this end, multiple provisioning networks may be located in the data center, with each one operated by a separate entity to provision and manage the devices in different ones of the compartments 29.

To automate the provisioning of servers and related types of devices in accordance with this exemplary provisioning framework, an agent can be installed on each device that is controlled by the network 31, to handle the retrieval and loading of software onto the device. The agent communicates with the provisioning network 31 to obtain commands regarding tasks that need to be performed on its device, as well as obtain the software components that are to be installed as part of the provisioning process. For more details regarding exemplary agents and their operation in automated provisioning systems, the interested reader is referred to U.S. patent application Ser. No. 09/699,354, filed on Oct. 31, 2000, entitled “Automated Provisioning Framework for Internet Site Servers”, the disclosure of which is incorporated here by reference.

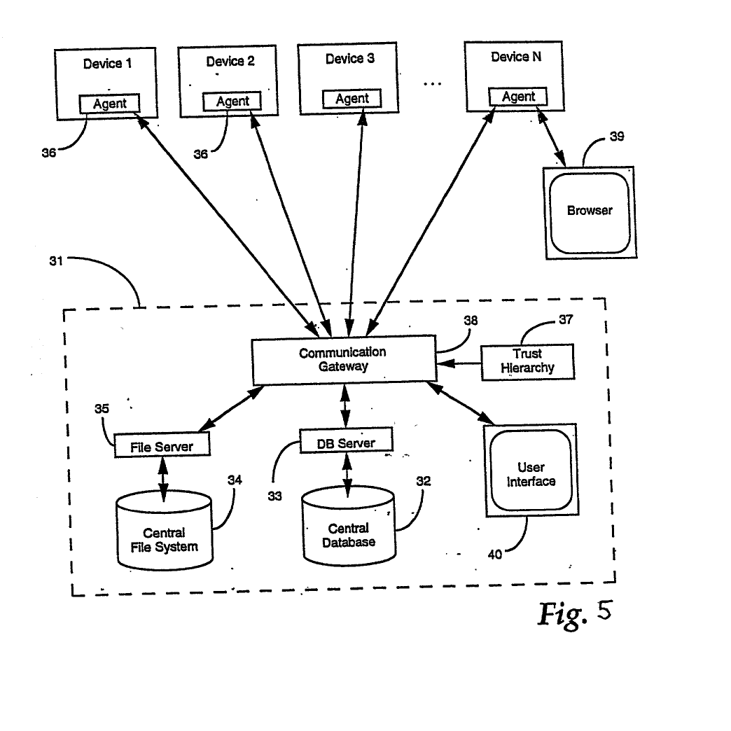

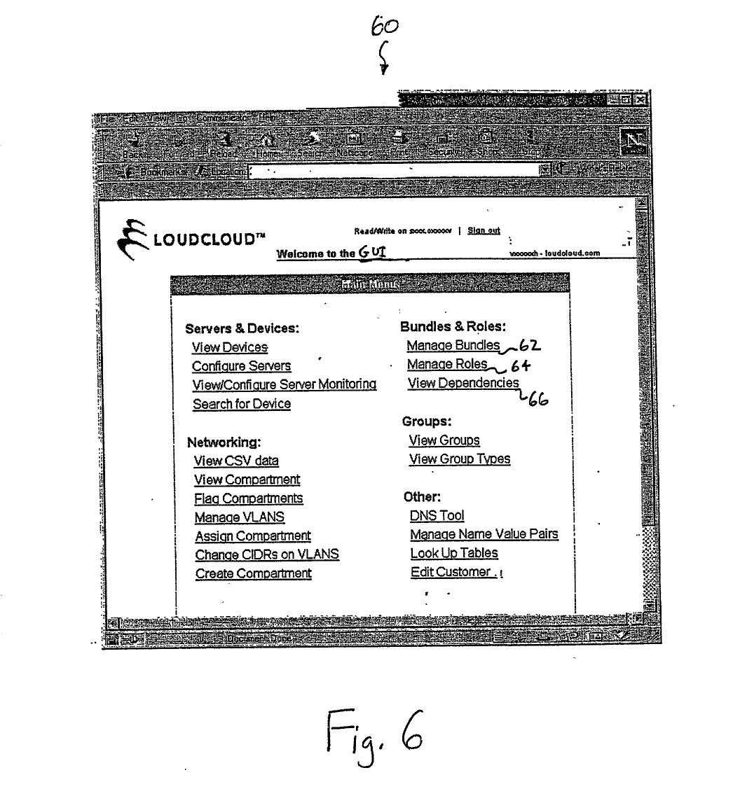

One example of a provisioning network 31 that communicates with the agents on individual devices, to perform automated provisioning, is illustrated in FIG. 5. Two fundamental functions are implemented by the provisioning network. One of these functions is to maintain information about, and manage, all of the devices that are associated with the provisioning system. The second function is to store and provide the software that is loaded on these devices. The first function is implemented by means of a central database 32, that is accessed via a database server 33. This database comprises a repository of all pertinent information about each of the devices that are connected to the provisioning network. Hence, depending upon the extent of the provisioning system, the central database might contain information about devices in only a few web site compartments, or an entire data center, or multiple data centers. The information stored in this database comprises all data that is necessary to provision a device. For instance, it can include the hardware configuration of the device, e.g., type of processor, amount of memory, interface cards, and the like, the software components that are installed on the device along with the necessary configuration of each of those components, and logical information regarding the device, such as its IP address, the web site with which it is associated, services that it performs, etc. For a detailed discussion of an exemplary model of such a database for storing all of the relevant information, reference is made to U.S. patent application Ser. No. 09/699,353, filed on Oct. 31, 2000, the disclosure of which is incorporated herein by reference. In essence, the information stored in the database constitutes a model for each device that is managed by the provisioning system, as well as the interconnection of those devices.

The second principal function of the provisioning network is implemented by means of a central file system 34, which is accessed via a file server 35. This file system stores the software that is to be installed on any of the devices under the control of the provisioning system. To facilitate the retrieval of a given item of software and forwarding it to a destination device, the software components are preferably stored within the file system as packages. One example of a tool that can be used to create software packages for a Linux operating system is the Red Hat Package Manager (RPM). This tool creates packages in a format that enables the contents of a package, e.g. the files which constitute a given program, to be readily determined. It also includes information that enables the integrity of the package to be readily verified and that facilitates the installation of the package, i.e., by including installation instructions that are built in to the RPM package. To support a different operating system, a packaging tool appropriate to that operating system, such as Solaris Packages for Sun operating systems or MSI for Microsoft operating systems, can also be employed. Regardless, all packages for all operating systems can be stored in the file system 34.

In operation, when the automated provisioning of a device is to be performed, a command is sent to an agent 36 on the device, instructing it to obtain and install the appropriate software. The particular software components to be installed are determined from data stored in the central database 32, and identified in the form of a Uniform Resource Location (URL), such as the address of a specific package in the file system 34. Upon receiving the address of the appropriate software, the agent 36 communicates with the central file system 34 to retrieve the required packages, and then installs the files in these packages onto its device. The commands that are sent to the agent also instruct it to configure the software in a particular manner after it has been loaded. Commands can also be sent to the agent to instruct it to remove certain software, to configure the network portion of the operating system, or to switch from a dynamically assigned network address to one which is static. To further enhance the security of the communications between the provisioning network and the agents, the network includes a central gateway 38 for communications.

There may be situations in which it is desirable to permit personnel who do not have access to the provisioning system per se to communicate with the agents. For instance, IT personnel at the entity hosting the site may need to perform some types of operations through the agent. In this case, the agent can be given the ability to communicate with a computer 39 external to the network, for instance by means of a browser on that computer. This external access can also serve as a debugging mechanism. For instance, a new configuration can be set up on a device and then tested in isolation on that device, via the browser, before it is deployed to all of the other devices of that same type. Whenever access to a device is sought by an entity outside of the secure network 28, the agent communicates with the gateway 38 to check with the trust hierarchy 37 and first confirm that the entity has the authority to access the device.

Another component of the provisioning system is a user interface 40 by which the devices are managed. The user interface 40 communicates with the gateway 38, which converts messages into the appropriate format. For instance, the gateway can convert SQL data messages from the database 32 into an XML (Extensible Markup Language) format which the user interface 40 then processes into a presentation format for display to the user. Conversely, the gateway converts procedure calls from the user interface into the appropriate SQL statements to retrieve and or modify data in the database 32. For a detailed description of one technique for performing such a conversion, reference is made to U.S. patent application Ser. No. 09/699,349, filed on Oct. 31, 2000, entitled “Object Oriented Database Abstraction and Statement Generation”, the disclosure of which is incorporated herein by reference.

In essence, the user interface 40 comprises a single point of entry for establishing the policies related to the management of the devices. More particularly, whenever a change is to be implemented in any of the devices, the device is not directly configured by an operator. Rather, through the user interface, the operator first modifies the model for that device which is stored in the database. Once the model has been modified, the changes are then deployed to the agents for each of the individual devices of that type from the data stored in the database, by means of the gateway 38. Preferably, the version history of the model is stored as well, so that if the new model does not turn out to operate properly, the device can be returned to a previous configuration that was known to be functional. The different versions of the model can each be stored as a complete set of data, or more simply as the changes which were made relative to the previous version.

An exemplary user interface according to the present invention will now be described with respect to FIGS. 6-11C. In FIG. 6, a main menu screen 60 associated with the user interface 40 is illustrated. Although this exemplary embodiment of a graphical user interface (GUI) according to the present invention is described in the context of a hierarchical, menu style GUI, those skilled in the art will appreciate that other user interface techniques could also be used to provide the same interface functionality. Therein, a plurality of links are provided for the user's selection to perform various interactions with the provisioning system, e.g., that described above, and/or to gather information associated with the provisioning system and the provisioned infrastructure. Although a user can select any of the illustrated links, in any order to access the lower hierarchical menus, this description will discuss the linked screens, and their associated functionality, in the order listed in FIG. 6. Since the present invention is primarily concerned with graphical user interfaces for software management in an automated provisioning system, only the GUI portions associated with links 62-66 are described in detail herein. Those readers interested in other graphical user interfaces associated with automated provisioning environments are directed to U.S. patent application Ser. No. ______, entitled “Graphical User Interface for Viewing and Configuring Devices in an Automated Provisioning Environment”, filed on an even date herewith (Attorney Dkt. No. 033048-013) and U.S. patent application Ser. No. ______, entitled “Graphical User Interface for Network Management in an Automated Provisioning Environment”, filed on an even date herewith (Attorney Dkt. No. 033048-047), the disclosures of which are incorporated here by reference.

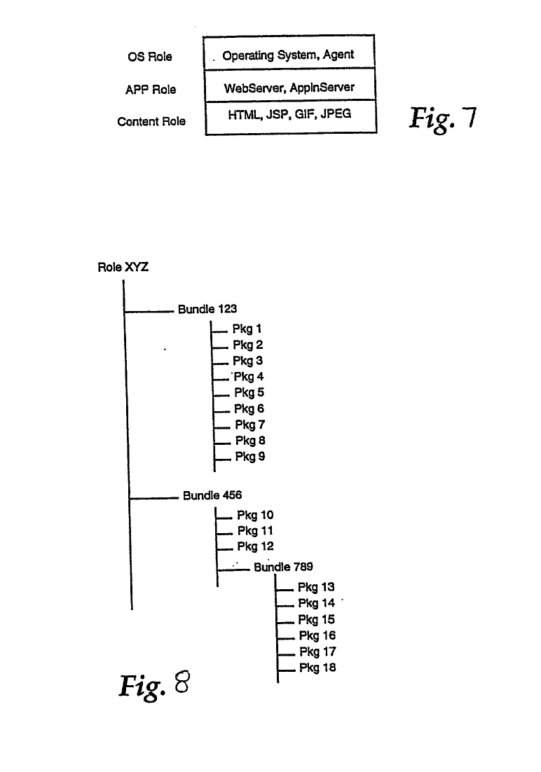

In the context of the exemplary embodiments described herein, software management across customer infrastructures supported in an automated provisioning environment is described in the context of bundles and roles. In one embodiment of the invention, the software components are classified into three types of roles that can be related to the frequency with which those components are likely to change, or be upgraded. Referring to FIG. 7, an OS role comprises the software which has the lowest probability of being changed during the life cycle of a device. This role consists of the operating system for the device, plus other general software. The next type of role, denoted an APP role, consists of software components that also change relatively infrequently, but perhaps more often than the operating system and the general software. This role comprises the application software that is assigned to a device, in accordance with the tasks that are to be performed by that device. Hence, the programs associated with the web server tier and the application server tier are contained in this role. The third type of role, denoted a Customer or Content role, consists of the software that can change on a regular basis for web site, such as HTML pages, Java server pages (JSP), image files, and other static content that is regularly updated by the web site host.

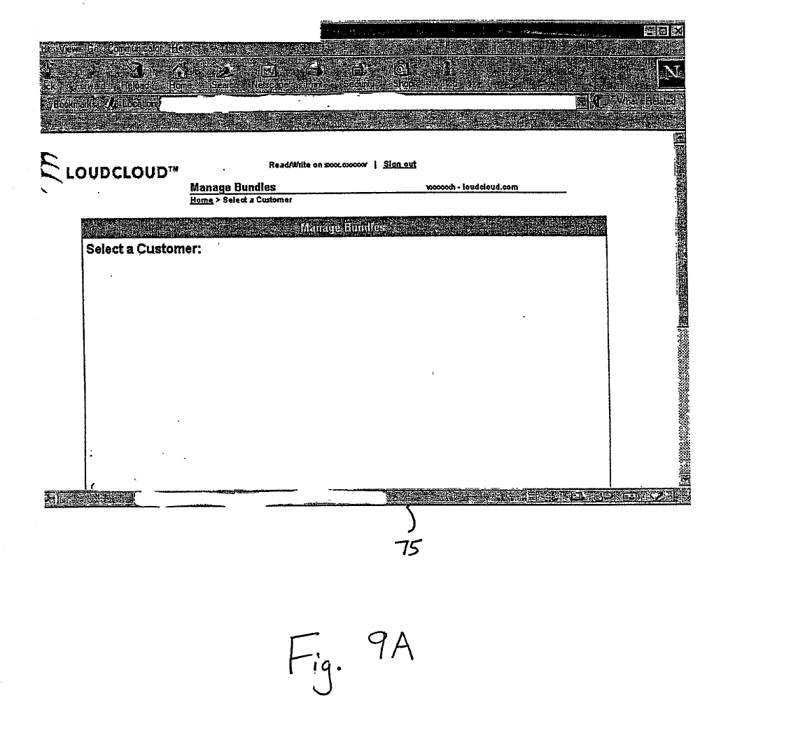

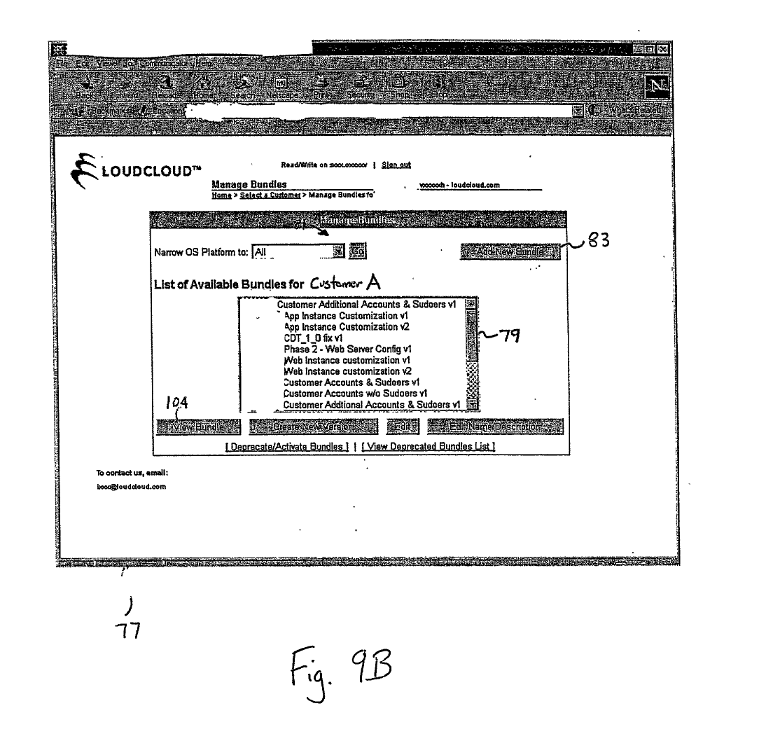

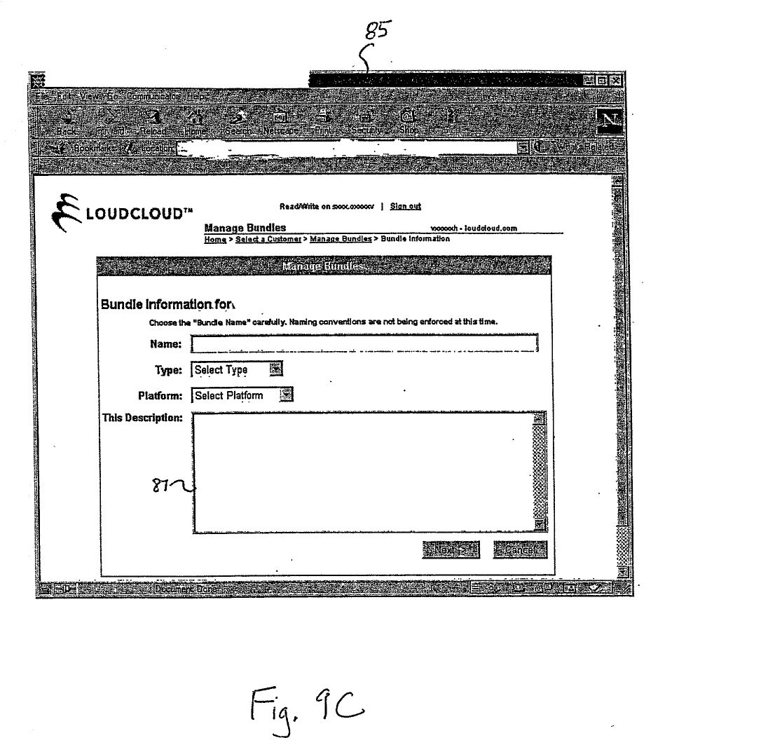

A given role comprises a hierarchical structure of specific software components. Referring to FIG. 8, a package comprises one or more files of a software component. A group of related packages forms a bundle. For example, a bundle may comprise all of the packages that constitute the files of a given program. A bundle can include another bundle as one of its components, as illustrated for the case of Bundle 456, which includes Bundle 789. A role, in turn, comprises multiple bundles, as well as the order in which those bundles are to be installed on a device. Within the database 32, the information about each role can be stored as a list of the packages contained within that role, in the order in which installation is to occur.

Each device, therefore, is assigned three roles, namely an OS role, an APP role and a Content role. If one of the tiers of a site needs to be scaled up by adding another server, the required device can be easily built by obtaining the appropriate OS role, APP role and Content role from the model information stored about that type of device in the database 32. Once the operating system and agent have been loaded onto a server, it can be connected to the provisioning network 31 and the software packages associated with each of the OS, APP and Content roles are retrieved from the file system 34, and provided to the agent 36, for installation and configuration on the device, to complete the provisioning.

This approach enhances the flexibility of the automated provisioning process, since each device to be provisioned is easily defined by its assigned roles, and hence different devices can be provisioned with different software, while the overall process remains the same. It also ensures repeatability, since all devices which are assigned the same roles will have the same software components. Furthermore, by partitioning the software for a device into different roles, each role can be upgraded separately from the other roles. Thus, as the content of a web site is changed, the packages for that role can be upgraded, without affecting the packages of the other roles, or impacting upon the provisioning process.

The definition of the roles to be assigned to a device and stored in the database 32 is carried out through the user interface 40. The different roles can be associated with different access rights, to thereby affect their ability to be manipulated. For instance, members of an IT department at the web site host may require access to their Content roles, so that they can regularly update the site. However, access to the OS roles may be limited to certain personnel at the data center or other entity which manages the web site infrastructure. The access rights associated with the different roles can be stored in the trust hierarchy 37.

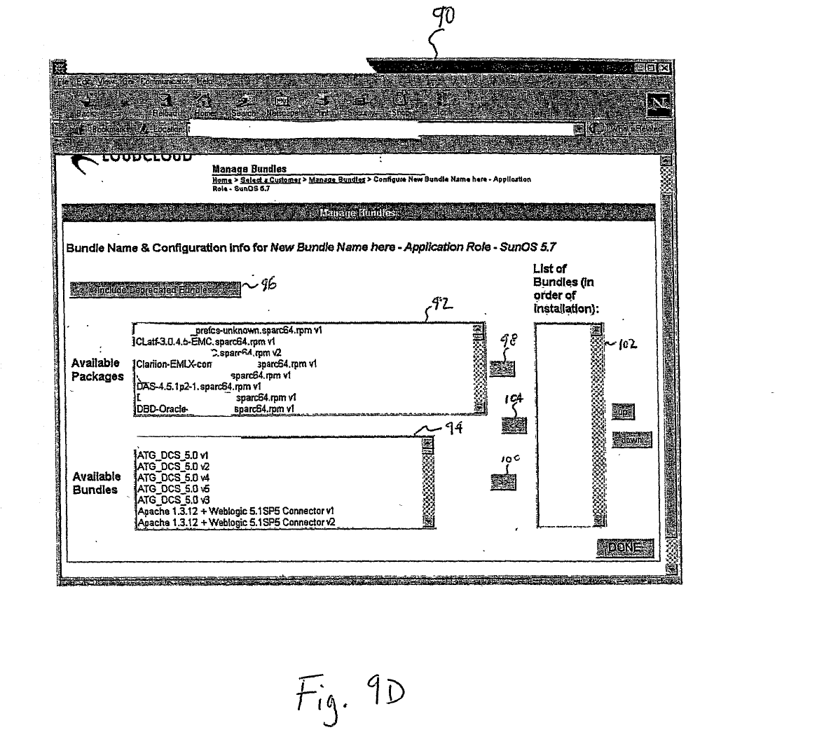

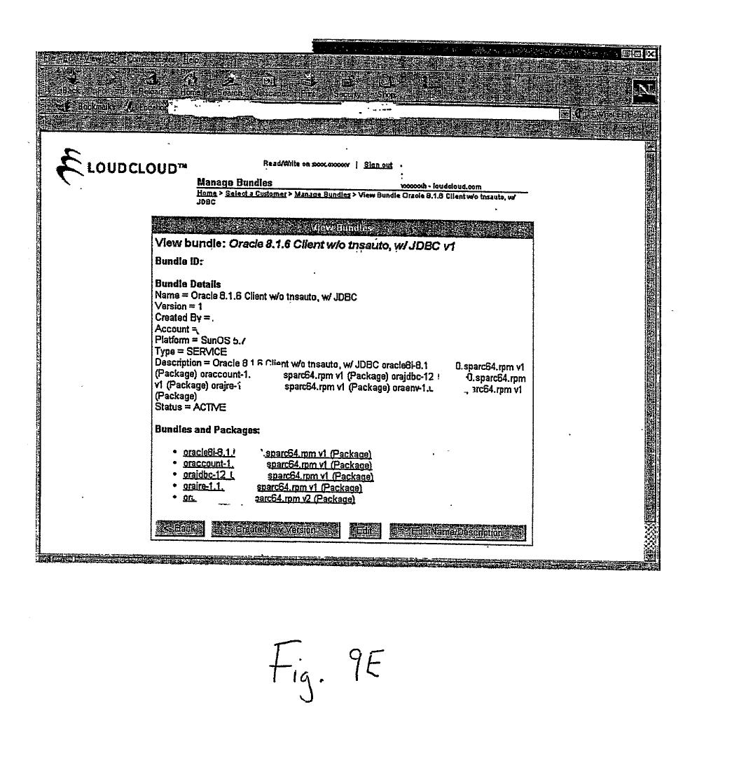

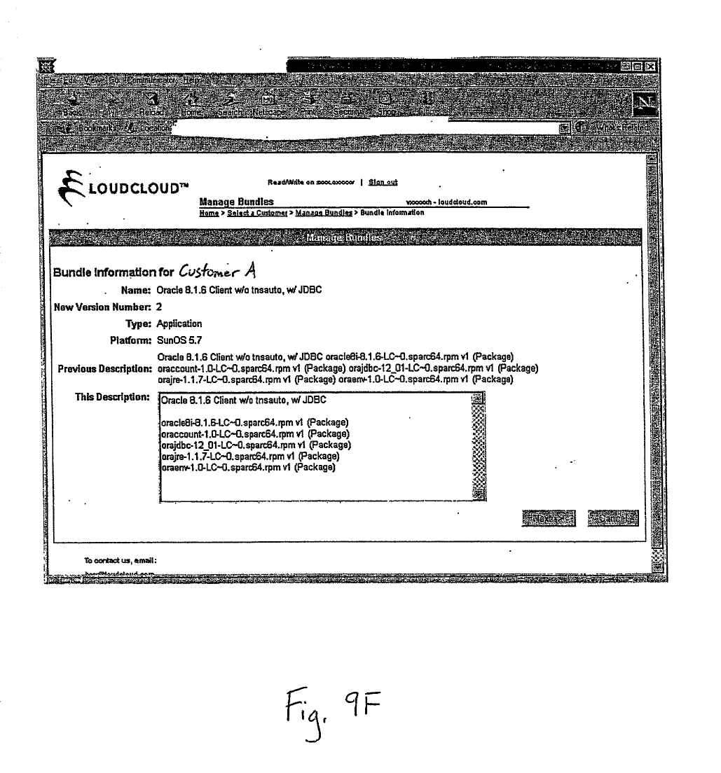

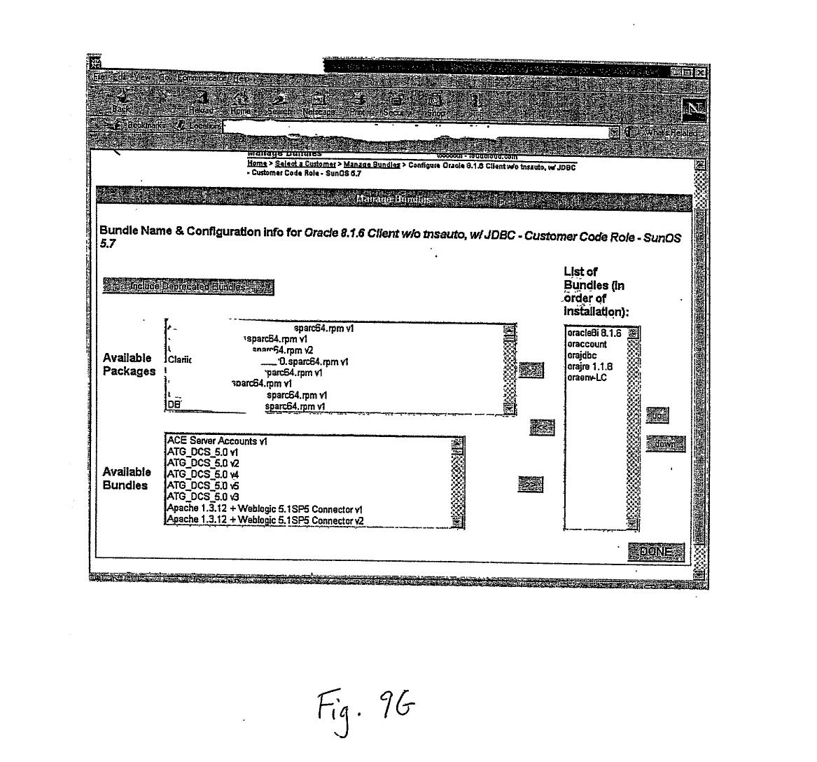

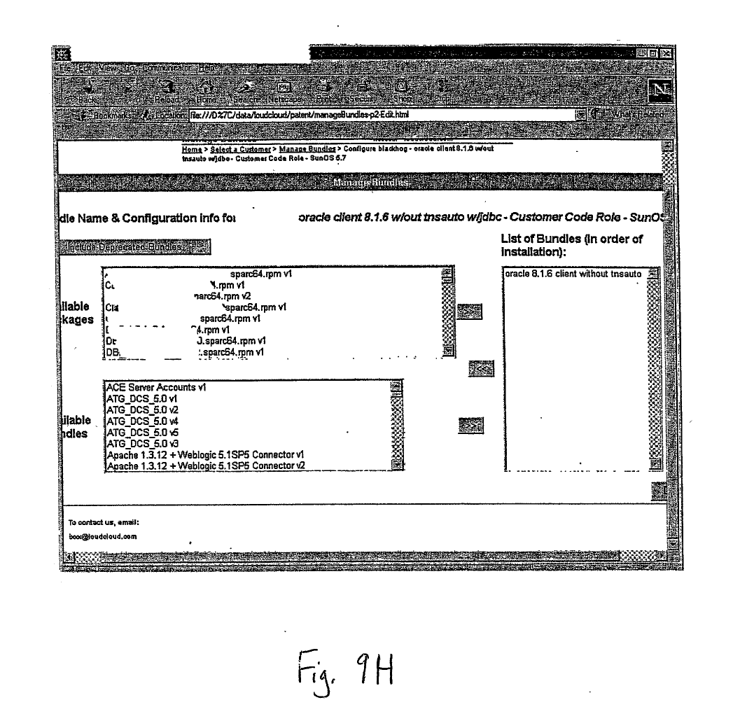

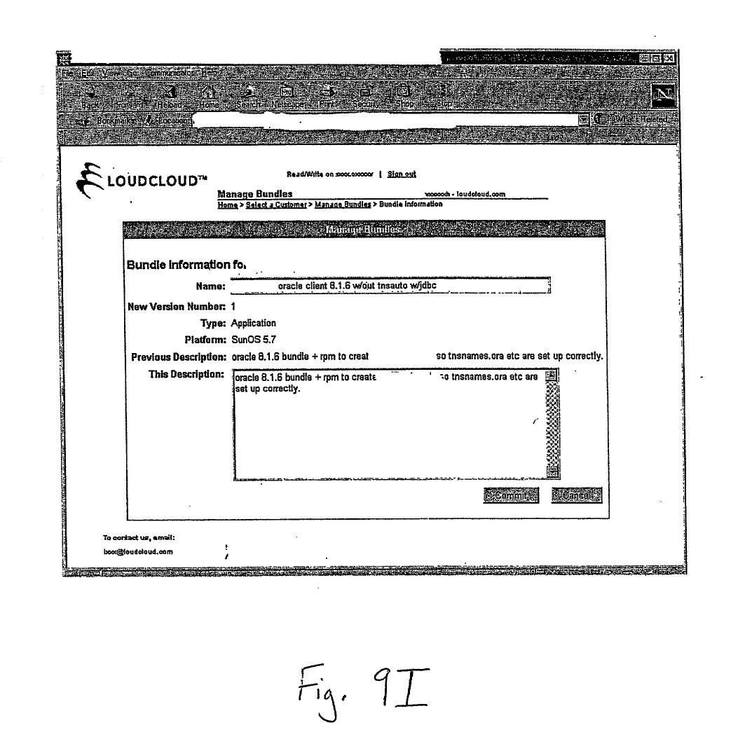

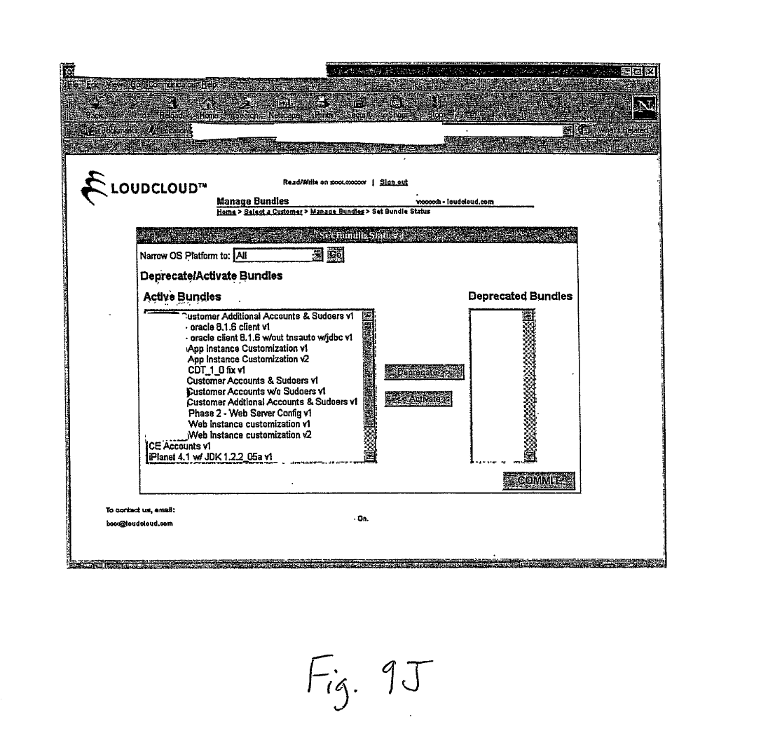

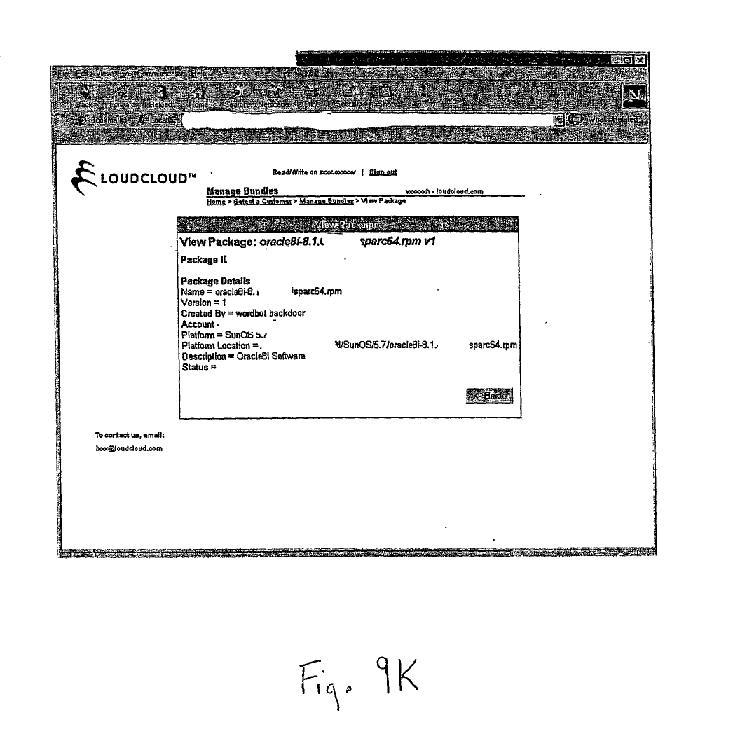

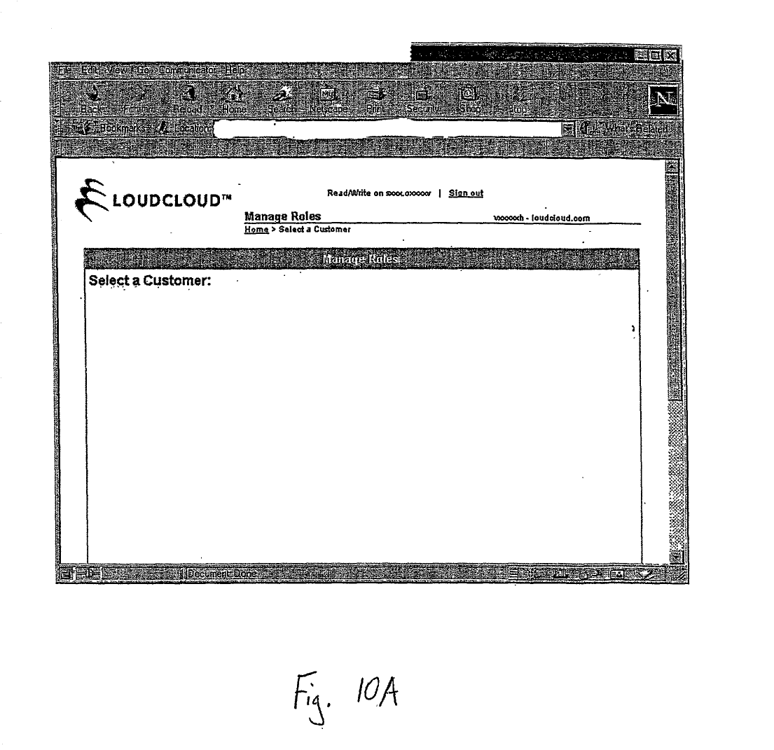

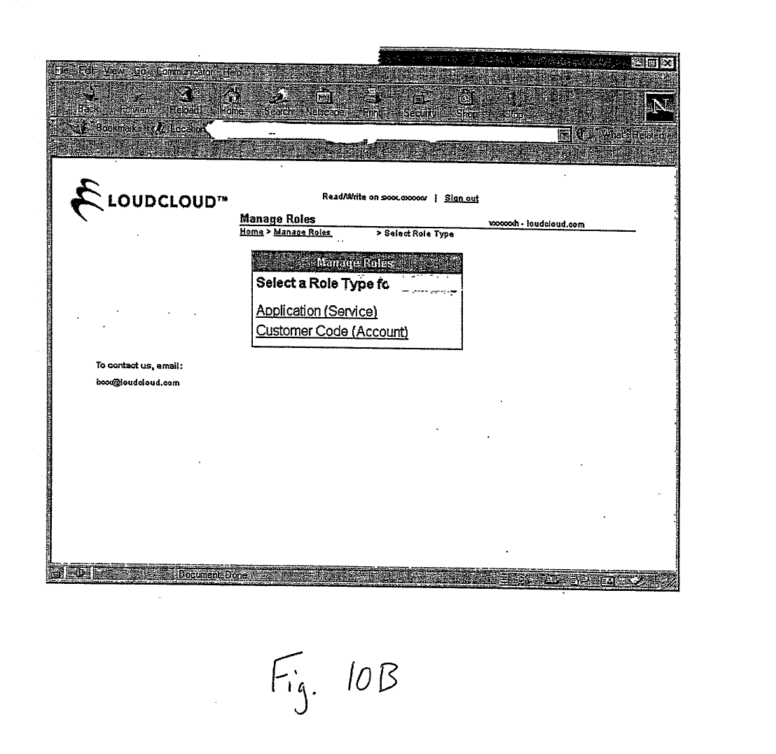

Exemplary graphical user interfaces for performing these, and other, software management functions according to the present invention will now be described. A user selecting the “Manage Bundles” link 62 at the main menu 60, e.g., by moving a cursor over the link and clicking thereon, can access the “Select a Customer” menu screen 75 depicted in FIG. 9A. Note that therein, and in subsequent screen shots of an exemplary graphical user interface according to the present invention, various alphanumeric information is blacked out to avoid disclosure of confidential, e.g., customer, information. The blacked out alphanumeric information is not, however, significant to the functionality of the exemplary user interface itself, which functionality is described and claimed herein.

In the exemplary GUI screen 75 in FIG. 9A, each customer has a link associated therewith for accessing subsequent screens that permit the GUI user to manage software associated with a particular customer. Those skilled in the art will appreciate that other GUI interface objects, e.g., menus, icons, etc. could be used to provide GUI selectability of customers. Having selected a particular customer for software management, the GUI will then provide the user with a list of the software bundles available for that particular customer's devices as illustrated, for example, in FIG. 9B. Therein, it can be seen that the GUI screen 77 includes a listbox 79 with the bundles available for the selected customer. Additionally, the user has the option of performing a number of different management functions with respect to that customer's software bundles.

For example, the user can filter the displayed bundles by operating system platform using GUI elements 81. Thus, if a user opted to select one of, for example, Sun OS 5.7 or Windows NT 4.0, as the platform filter, the listbox 79 would be updated to display only those bundles which operate on the selected platform. GUI screen 77 also includes an “Add New Bundles” button 83. Using this GUI element, the user can add new software to the list of bundles which is associated with the selected customer. According to exemplary embodiments of the present invention, a GUI screen 85 (FIG. 9C) can be displayed upon actuation of button 83. Therein, the user is prompted to input the name for the bundle to be added. Additionally, GUI screen 85 prompts the user to type the new bundle, e.g., as one of application code or customer code, which permits the role assignment to be made by the provisioning system 31 for the new bundle. The user can also select the operating system platform associated with the bundle to be added and can add a text description of the bundle in the illustrated text entry box 87 or any other type of GUI data entry element. For some customers, it may further be desirable to permit users to select OS software roles and bundles for creation.

Having provided this basic information for a new bundle to be added for management by the provisioning system 31, actuating the “Next” button in GUI screen 85 will result in graphical user interfaces according to exemplary embodiments of the present invention providing the user with the ability to select various software for inclusion within the bundle. Turning now to FIG. 9D, according to this exemplary embodiment, the user is presented with lists of available software packages, e.g., RPM packages and lists of available bundles, i.e., previously created bundles, for inclusion in the new bundle. Note that, in order to promote software security and confidentiality, graphical user interfaces according to the present invention will only present those packages and bundles which have been authorized for the particular customer which has been selected to avoid inadvertent loading of another customer's software. In this example, as seen in the screen 90's title information, the user has identified the new bundle as containing application code and being associated with the Sun OS 5.7 platform. Thus, the lists of packages and bundles displayed in listboxes 92 and 94, respectively, will contain only those packages and bundles which are available for this particular customer on the user-selected platform for this new bundle. Additionally, the user can, optionally, include deprecated bundles in listbox 94 by actuating button 96. Deprecated bundles refer to bundles that have been designated by system operators to be suboptimal, e.g., that include older versions of software. In its default state, listbox 94 will not list deprecated bundles for selection. However, there may be instances where a GUI user nonetheless desires that a deprecated bundle be included within a new bundle, e.g., legacy usage of certain software in a particular customer's infrastructure. Accordingly, depressing the deprecated bundle button 96 will include those roles in the list provided in box 94.

Clicking on a listed package or bundle selects that item, which can then be added to the new bundle by using the double-arrow buttons 98 and 100, respectively. The GUI will then populate the listbox 102 with the selected package or bundle, e.g., using a Java script. Similarly, packages or bundles can be deselected from listbox 102 by clicking on an item to highlight it and then actuating double-arrow button 104. As indicated in the GUI screen 90, the items are intended to be listed by the user in listbox 102 in their order of installation, i.e., when this newly created bundle is subsequently selected for installation on a particular device associated with this customer, the packages and/or bundles associated with this new bundle will be installed in the listed order. This is one of the mechanisms by which graphical user interfaces according to the present invention are able to assist in the uniformity and management of software configuration for different customer across different infrastructures. The “Up” and “Down” buttons depicted in FIG. 9D provide mechanisms for the user to change the order of items listed within listbox 102 to vary the loading order before completing the new bundle creation process.

Returning to GUI screen 77 of FIG. 9B, in addition to adding new bundles of software for a particular customer, the user can also view existing buttons, e.g., by actuating button 104. This action results in the GUI displaying, for example, an informational screen associated with the selected bundle, an example of which is provided as FIG. 9E. Therein, the user is able to view all of the information entered upon creation of the bundle, as well as an automatically generated version number for the bundle itself. If more information about one of the packages or bundles which are included within the viewed bundle is desired, the user can actuate the corresponding link at the bottom of this screen, which results in the GUI providing a further informational screen for the selected package, an example of which is found in FIG. 9J.

From either of the GUI screens of FIGS. 9B or 9E, the user is able to create a new version of a selected bundle, e.g., to vary the loading order of the bundle and/or the description. Actuating the “Create New Version” button can, therefore, result in the GUI displaying screens such as those illustrated in FIGS. 9F and 9G, wherein the user can adjust the description or the type, number and/or order of software package/bundles for the bundle named “Oracle 8.1.6. . . ” to create new version number 2 for that bundle. The user can also edit a bundles without creating a new version of that bundle by actuating the “Edit” button in FIG. 9B. The resulting GUI screen, an example of which is depicted as FIG. 9H, permits the user to manipulate the type, number and order of software packages/bundles within the selected bundle. Similarly, the user can edit only the name and description by actuating the corresponding button in the exemplary GUI screen of FIG. 9B. This results in a bundle name/description editing screen, exemplified by FIG. 9I, being generated by the GUI.

FIG. 9B also provides the user with a link for setting a bundle's status as either deprecated or active. Actuating this link results in another GUI screen, e.g., as shown in FIG. 9J, which permits the user to deprecate and/or activate bundles associated with a particular customer. This GUI screen also includes an OS platform filter to limit the bundles under consideration for a status change. From the GUI screen of FIG. 9B, the user can also view a list of only those bundles which have been deprecated.

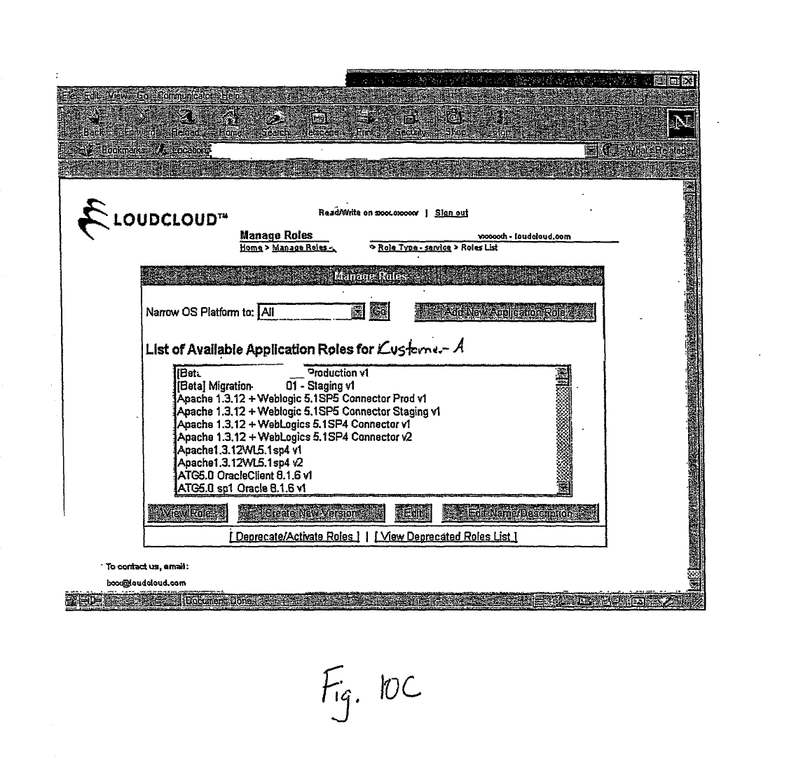

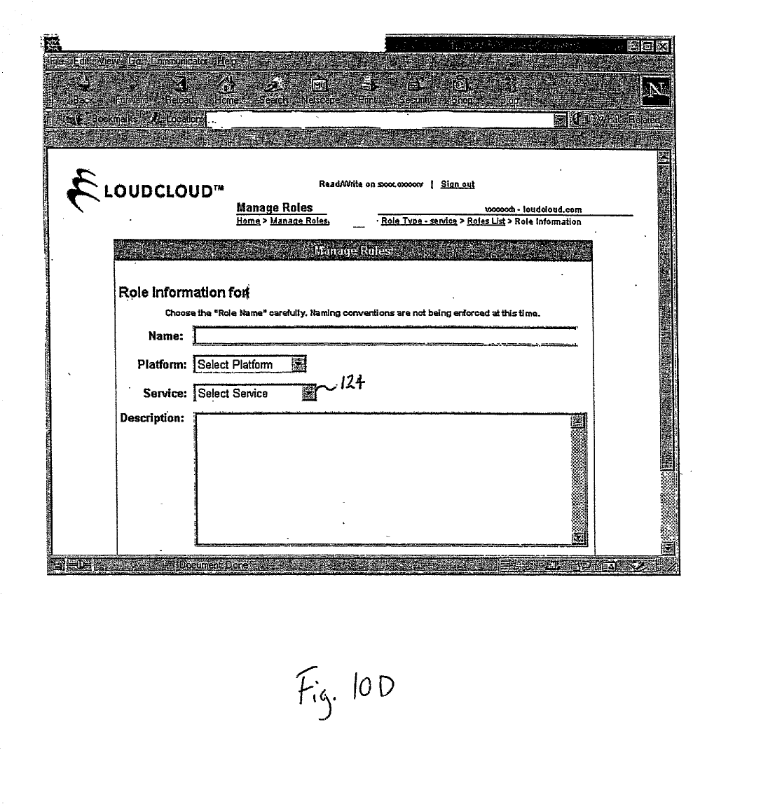

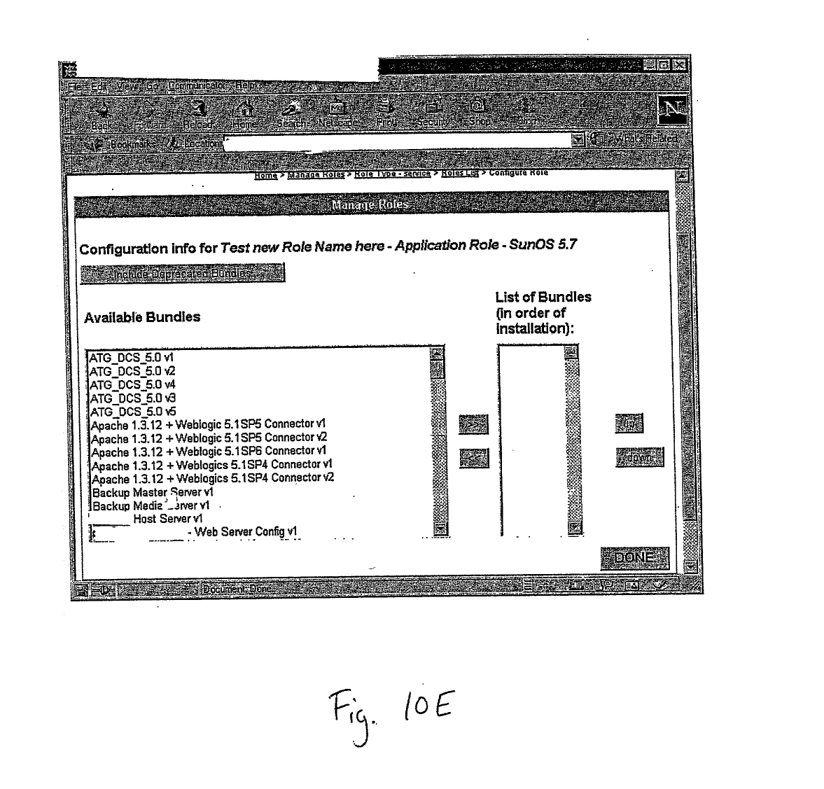

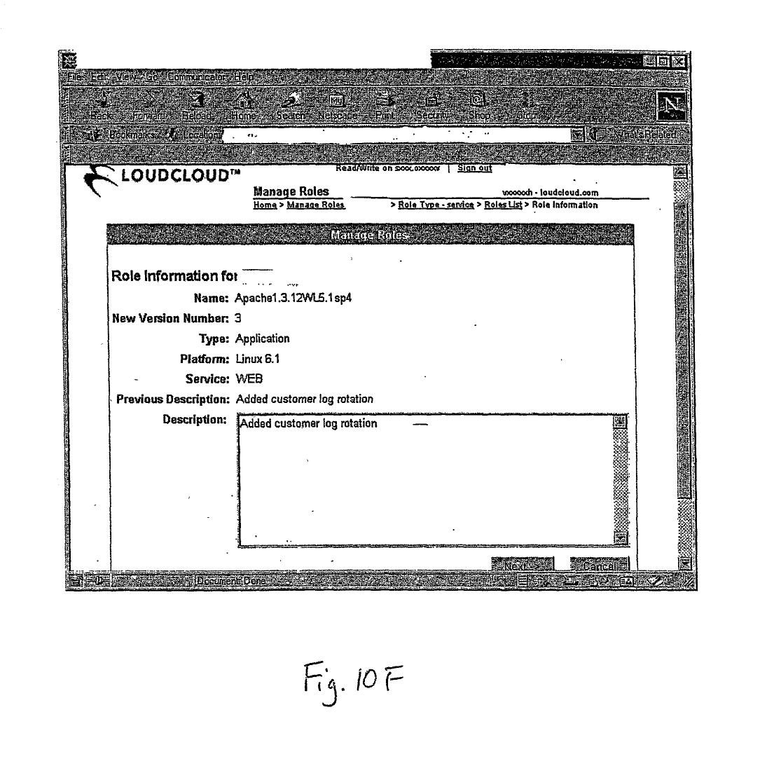

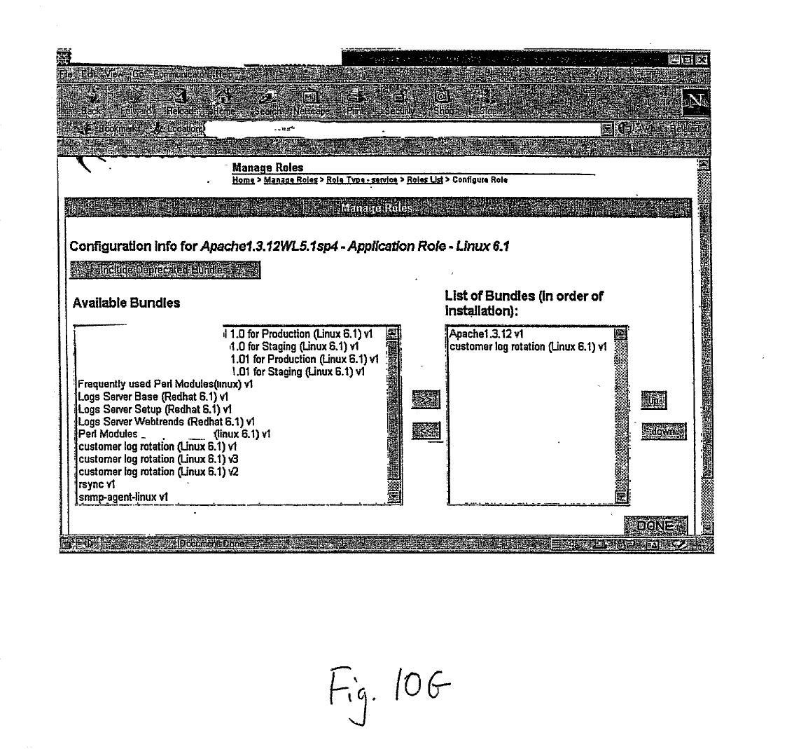

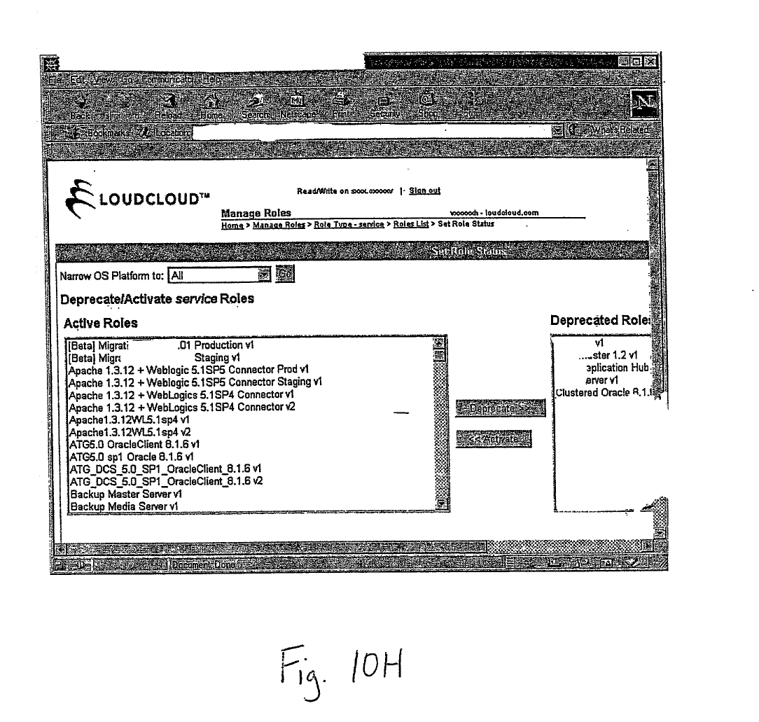

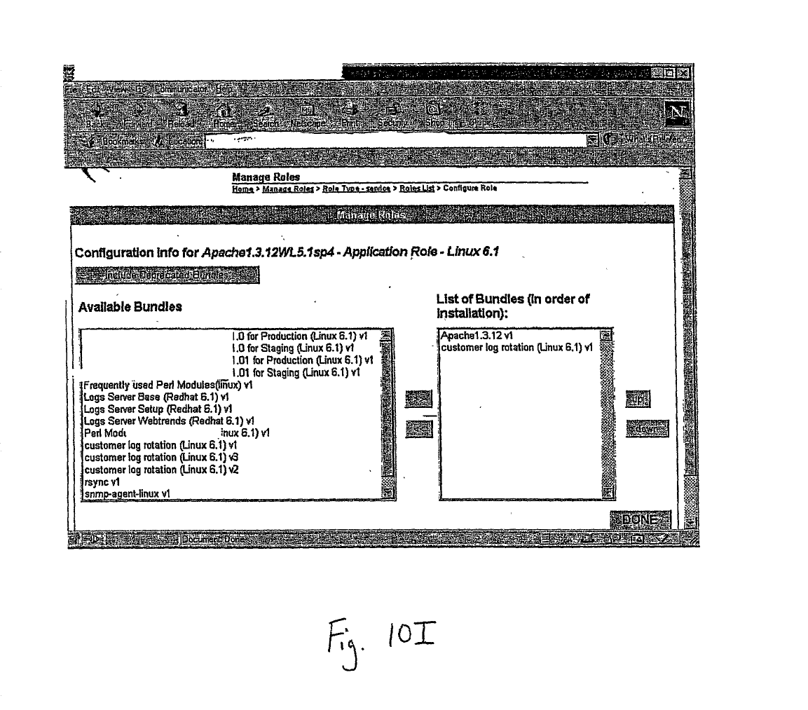

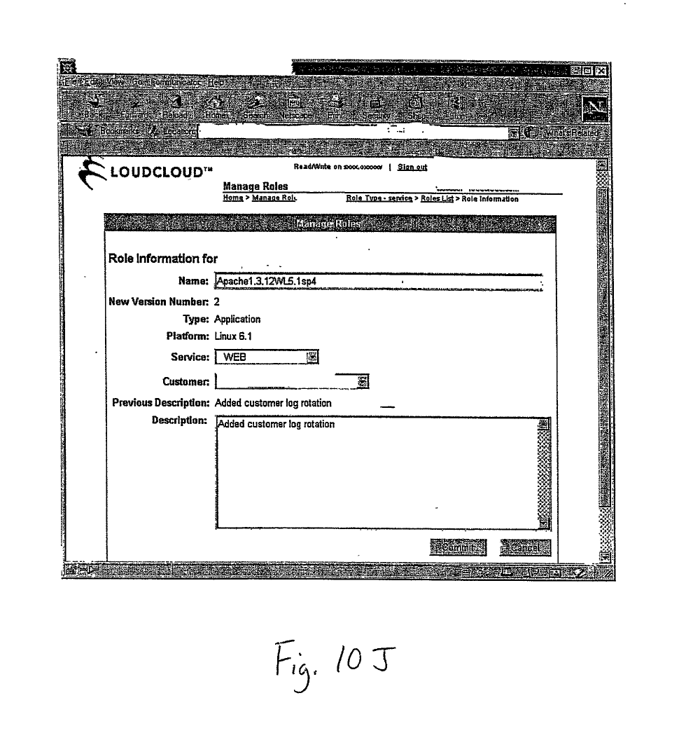

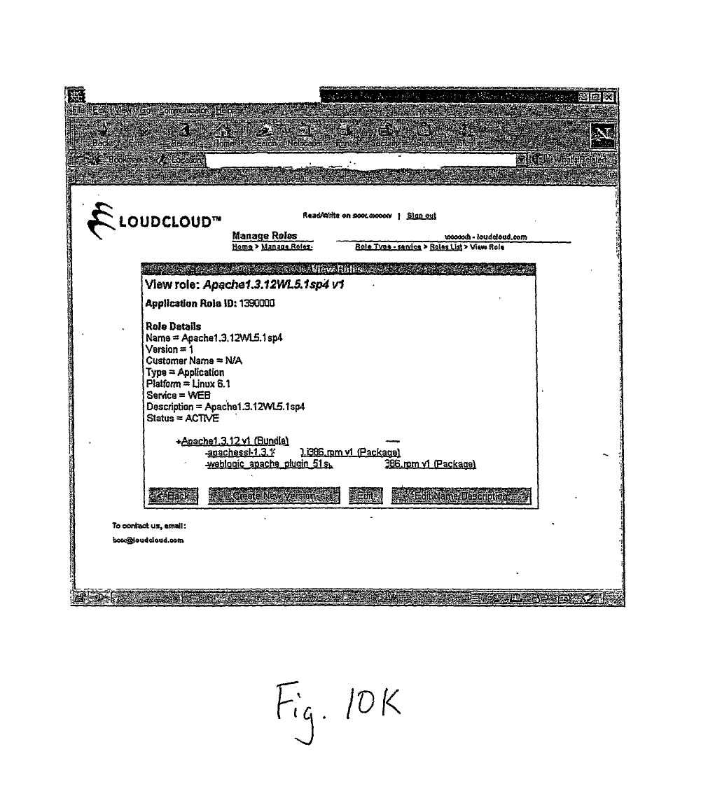

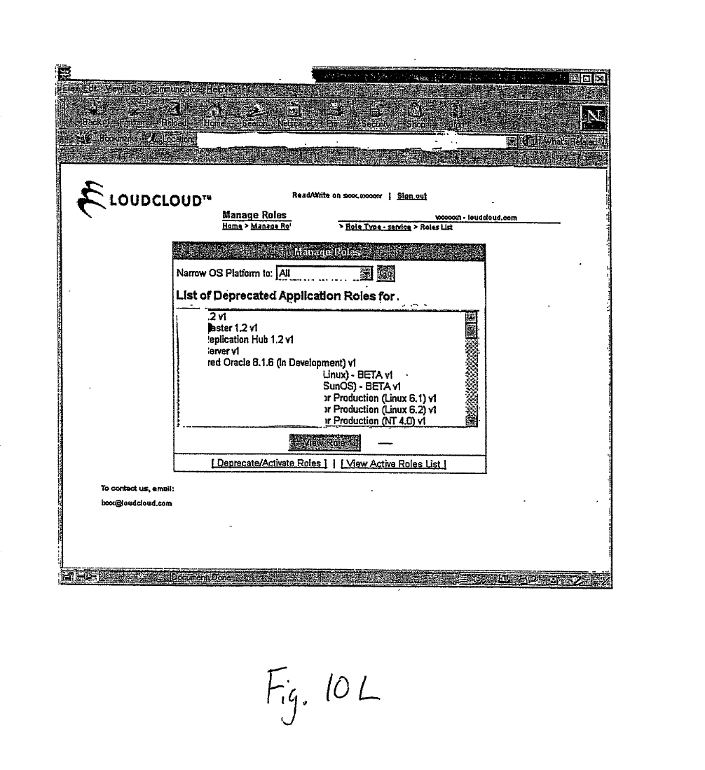

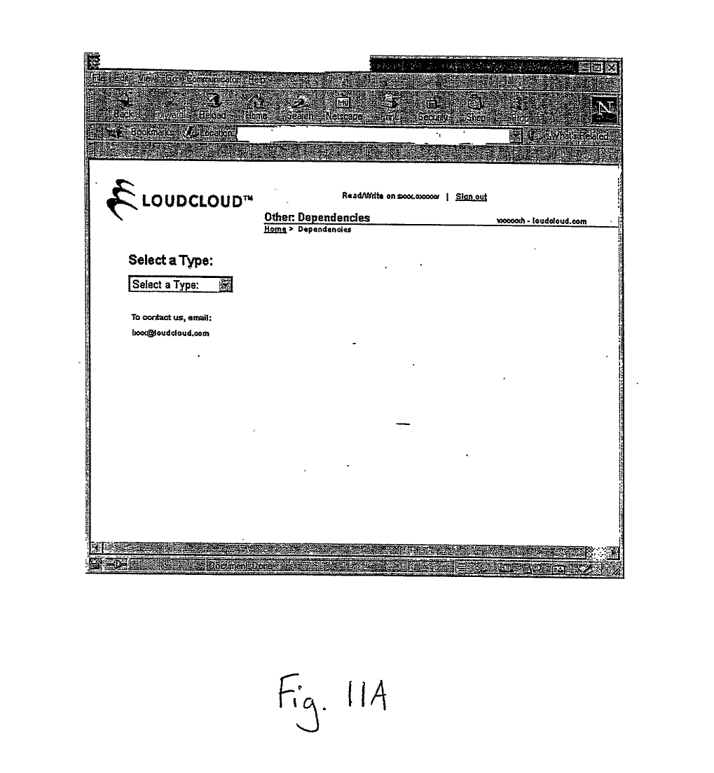

As an alternative to managing software in the automated provisioning network 31 from a bundle perspective, users of graphical interfaces according to the present invention are also able to manage customer software based on the role associated with that software, as will now be described with respect to FIGS. 10A-10L. Referring to FIG. 10A, which can be reached by actuating link 64 in the GUI screen of FIG. 6, the user is first prompted to select a customer. Next, as illustrated in FIG. 10B, the user selects a role type for software management, in this example either an application (service) role or a customer code (account) role. As mentioned previously, it may be desirable, for certain customers or operators with the appropriate rights, to permit the selection of an OS role for management as well. Selecting, for example, management of application roles for customer A, results in the GUI generating the application role management screen 120, an example of which is illustrated as FIG. 10C. Those skilled in the art will appreciate that those GUI objects in FIG. 10C which correspond to GUI objects depicted in FIG. 9B operate in a similar manner, except that they permit software management from a role perspective rather than a bundle perspective. Accordingly, the following discussion will focus primarily on exemplary differences between graphical user interfaces for role software management and bundle software management according to the present invention and incorporate by reference the previous discussions of FIGS. 9A-9K for the similarities to avoid some redundancy in this description. For example, using the “Add New Application Role” button in FIG. 10C results in the screens of FIGS. 10D and 10E being generated. These GUIs are similar to those depicted in FIGS. 9C and 9D for adding new bundles. However, role creation according to exemplary embodiments of the present invention, also has associated therewith a service designation as shown by GUI element 124 in FIG. 10D. This permits the user to select the service associated with the role being created, e.g., web service, database service, etc., which service is then entered into the model stored in database 32. These service designations can be used by the automated provisioning system 31 to, for example, customer report generation to organize device or software descriptions for customers regarding their infrastructures.

In a manner similar to that described above with respect to FIGS. 9F and 9G, a new version of a role can be created by actuating the corresponding button in FIG. 10C and making the desired changes in the resultant GUI screens, e.g., those depicted in FIGS. 10F and 10G. Likewise, role status (deprecated or active) can be managed using the exemplary GUI screen illustrated as FIG. 10H, role editing can be managed using the exemplary GUI screen illustrated as FIG. 10I, and role description editing can be managed using the exemplary GUI screen illustrated as FIG. 10J. Actuating the “View Role” button from any of the illustrated GUI screens where that button is available provides more information on the selected role, including the bundle(s) and/or package(s) associated with that role as seen in FIG. 10K. Lastly, the user can also view the list of deprecated roles for a particular customer as seen in FIG. 10L.

Thus, graphical user interfaces according to the present invention provide a controlled manner in which to manage software associated with different customers from at least two different perspectives. At a lower level, bundle management permits the user to manage software configurations based on the software package grouping. At a somewhat higher level, groups of bundles can be managed by using the role management features described above. This eases the reconfiguration and reuse of software within customer infrastructures while, at the same time, enforcing segregation of software between customer infrastructures.

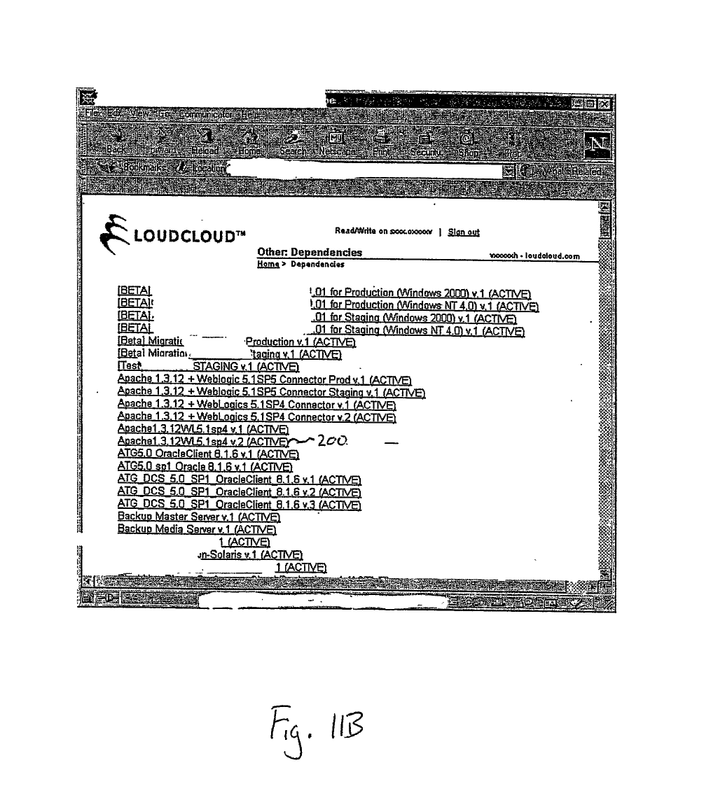

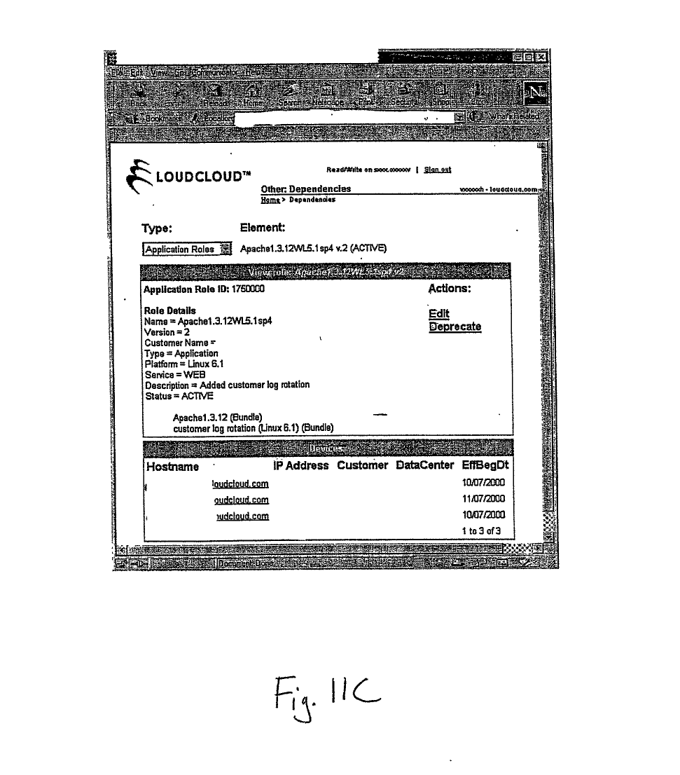

Actuating link 66 in FIG. 6 results in graphical user interfaces according to the present invention providing the user with the opportunity to determine which devices and/or customers are using certain software bundles and/or roles. For example, if an upgrade becomes available for a particular piece of software, and the user wishes to know which devices are eligible for, or might benefit from, such an upgrade, this GUI functionality will be useful. Thus, actuating link 66 results in generation of the GUI screen of FIG. 11A according to this exemplary embodiment. Therein, the user is prompted to select a type of software for which dependency management is desired, e.g., bundles, operating system roles, application roles or customer roles. Upon selecting a software type for dependency management, the user is presented with a list of qualifying bundles or roles. For example, the selection of application roles in FIG. 11A might result in the exemplary list of application roles in FIG. 11B.

Each role listed therein can be accessed as a link to reveal its dependencies. For example, if the user actuates the link 200, the dependencies for that role will be provided as well as details associated with the software included within that role. An example is provided as FIG. 11C. Therein, the user is provided with information regarding which customers and devices use the selected role. In this exemplary embodiment, the user is provided with information regarding the hostname, IP address, customer name, data center and effective beginning date for each device that employs the selected role. From this GUI segment, the user is able to either edit the role (which link returns the user to, e.g., one or more of the edit GUI portions described above) or to deprecate the role, in which it would no longer be available (as a default) for inclusion in a bundle of software to be installed on a customer's device.

From the foregoing, it will be appreciated that graphical user interfaces according to the present invention provide mechanisms and methods for enhancing software management, particularly within automated provisioning environments. Among other things, these graphical user interfaces provide mechanisms for easily and rapidly managing the way in which software is loaded onto customers' devices while at the same time protecting each individual customer's software security and confidentiality. This latter feature is achieved by, for example, limiting actions to be performed by the user to GUI portions which relate to only one customer. From the foregoing description it will be apparent that those GUI portions which list multiple customers typically do not include GUI action elements, which are reserved for GUI portions relating to individual customers. Additionally, those GUI portions that are associated with individual customers only list, and provide management action options for, software associated with that customer.

It will be appreciated by those of ordinary skill in the art that the present invention can be embodied in other forms without departing from the spirit or essential characteristics thereof. For instance, while an exemplary embodiment of the invention has been described in the context of provisioning web site servers in a data center, it will be appreciated that the principles underlying the invention can be applied in any environment where computing devices need to be configured and/or updated on a relatively large scale. The foregoing description is therefore considered to be illustrative, and not restrictive. The scope of the invention is indicated by the following claims, and all changes that come within the meaning and range of equivalents are therefore intended to be embraced therein.

What is claimed is:

1. A graphical user interface (GUI) for management of software associated with a plurality of customers, said graphical user interface comprising:
a first user interface element actuable to access a portion of said graphical user interface, which portion displays a list of software groups which are available for management for one of said plurality of customers.

2. The graphical user interface of claim 1, wherein said first user interface element is a link which is actuable via a pointing device and a cursor displayed on said graphical user interface.

3. The graphical user interface of claim 1, wherein said first portion of said graphical user interface includes a screen wherein a user can select said one of said plurality of customers to access said list of software groups.

4. The graphical user interface of claim 1, wherein said first portion includes a GUI mechanism for filtering said list of software groups based on a selected operating system platform.

5. The graphical user interface of claim 1, wherein each of said software groups is a bundle of software, each bundle of software including at least one software package.

6. The graphical user interface of claim 5, wherein said at least one software package is a Red Hat Package Manager (RPM) package.

7. The graphical user interface of claim 1, wherein each of said groups of software is a role.

8. The graphical user interface of claim 7, wherein each said role includes at least one bundle of software.

9. The graphical user interface of claim 8, wherein each bundle of software includes at least one software package.

10. The graphical user interface of claim 9, wherein said at least one software package is a Red Hat Package Manager (RPM) package.

11. The graphical user interface of claim 1, further comprising:
at least one GUI mechanism actuable to add a new software group to said list of software groups.

12. The graphical user interface of claim 11, wherein, subsequent to actuation of said at least one GUI mechanism for adding a new software group, said user is presented with a data entry screen which permits said user to enter a name for said new software group.

13. The graphical user interface of claim 11, wherein, subsequent to actuation of said at least one GUI mechanism for adding a new software group, said user is presented with a data entry screen which permits said user to enter a type for said new software group.

14. The graphical user interface of claim 13, wherein said type is one of: application code and customer code.

15. The graphical user interface of claim 11, wherein, subsequent to actuation of said at least one GUI mechanism for adding a new software group, said user is presented with a data entry screen which permits said user to enter a platform for said new software group.

16. The graphical user interface of claim 11, wherein, subsequent to actuation of said at least one GUI mechanism for adding a new software group, said user is presented with a data entry screen which permits said user to enter a description for said new software group.

17. The graphical user interface of claim 11, wherein, subsequent to actuation of said at least one GUI mechanism for adding a new software group, said user is presented with a data entry screen which permits said user to enter a service associated with said new software group.

18. The graphical user interface of claim 17, wherein said service is one of: web and database.

19. The graphical user interface of claim 11, wherein, subsequent to actuation of said at least one GUI mechanism for adding a new software group, said user is presented with a screen which permits said user to select one or more available packages for said new software group.

20. The graphical user interface of claim 11, wherein, subsequent to actuation of said at least one GUI mechanism for adding a new software group, said user is presented with a screen which permits said user to select one or more available bundles for said new software group.

21. The graphical user interface of claim 19, wherein said available packages include only those software packages that are associated with said one of said plurality of customers.

22. The graphical user interface of claim 20, wherein said available bundles include only those software packages that are associated with said one of said plurality of customers.

23. The graphical user interface of claim 11, wherein, subsequent to actuation of said at least one GUI mechanism for adding a new software group, said user is presented with a screen which permits said user to select an order of installation for software modules within said new software group.

24. The graphical user interface of claim 1, wherein said portion of said graphical user interface includes at least one GUI mechanism which permits said user to select one of said software groups and perform an action with respect thereto.

25. The graphical user interface of claim 24, wherein said action is viewing details of said selected one of said software groups.

26. The graphical user interface of claim 25, wherein said details include a version number of said selected one of said software groups.

27. The graphical user interface of claim 24, wherein said action is creating a new version of said selected one of said software groups.

28. The graphical user interface of claim 24, wherein said action is editing one of a description of said selected one of said software groups and software contents of said selected one of said software groups.

29. A graphical user interface (GUI) for management of software associated with a plurality of customers, said graphical user interface comprising:
at least one GUI mechanism for determining on which of a plurality of devices associated with said plurality of customers that a specific software unit is installed.

30. The graphical user interface of claim 29, wherein said at least one GUI mechanism includes a list of software units associated with said plurality of customers.

31. The graphical user interface of claim 29, wherein said software unit is a bundle including at least one package.

32. The graphical user interface of claim 29, wherein actuation of said at least one GUI mechanism results in a display of all of the devices within a network that includes said specific software unit.

33. The graphical user interface of claim 32, wherein said display identifies said devices by customer name.

34. The graphical user interface of claim 32, wherein said display identifies said devices by hostname.

35. The graphical user interface of claim 32, wherein said display identifies said devices by IP address.

36. The graphical user interface of claim 32, wherein said display identifies said devices by data center.

37. The graphical user interface of claim 29, further comprising:
means for deprecating said specific software unit.
